(19) United States
(12) Patent Application Publication
(10) Pub. No.: US 2012/0325095 A1
(43) Pub. Date: Dec. 27, 2012

(54) Griddle Pan

(75) Inventor: Edward Michael O'Donnell, Maidenhead (GB)

(73) Assignee: Edward Michael O'Donnell, Maidenhead, Berkshire (GB)

(21) Appl. No.: 13/581,129

(22) PCT Filed: Feb. 25, 2011
(86) PCT No.: PCT/EP2011/052804

§ 371 Date: Aug. 24, 2012

(30) Foreign Application Priority Data
Feb. 26, 2010 (GB) 1003243.1
Feb. 25, 2011 (EP) PCT/EP2011/052804

(51) Int. Cl. A47J 37/10

(52) U.S. Cl. 99/425

(57) ABSTRACT

A griddle pan for domestic use, having a base, a plurality of ridges extending upwardly from the base, and gulleys between successive ridges. The pan includes a plurality of barriers, each barrier being arrangable between successive ridges, at a height at or lower than the height of successive ridges. The barriers allow liquid to flow from tops of ridges towards the gulleys, and the barriers being arrangable to prevent at least some liquid from spitting from the gulley away through the space between the tops of successive ridges and away from the pan.

This invention is concerned with improvements in or relating to a griddle pan and is especially concerned with improvements in a griddle pan comprising means for reducing the spitting and/or splashing of cooking juices and fats from the pan when in use.

Traditional griddle pans may be round or square and comprise raised ridges for supporting products to be cooked thereon. The aim of the ridges is to facilitate the even cooking of the products and to enhance the colour, flavour and visual appearance of the cooked products.

One of the main disadvantages of conventional griddle pans is the tendency for the juices and fats that are exuded from the products being cooked is the spitting and/or splashing of the juices and fats from the products that are lying in the juices and/or fats.

These problems become more apparent as a cook bastes the food product or they use cooking oil to prevent the food products from sticking to the ridges of the griddle pan, or foods having high fat content are cooked.

It is an object of the present invention to provide an improved griddle pan wherein the disadvantages of conventional griddle pans are overcome or at least greatly reduced.

According to a first aspect of the invention there is provided a griddle pan for domestic use, comprising, a base, and a plurality of ridges extending upwardly from the base, gulleys between successive ridges, characterised in that the pan comprises a plurality of barriers, each barrier being arrangable between successive ridges, at a height at or lower than the height of successive ridges, the barriers allow liquid to flow from tops of ridges towards the gulleys, and the barriers being arrangable to prevent at least some liquid from spitting from the gulley away through the space between the tops of successive ridges and away from the pan.

The griddle pan may comprise one or more feature or features which are set out in the dependent claims and/or in the description below.

Thus, the present invention conveniently provides a griddle pan comprising an arrangement of ridges and bars wherein the ridges are set at a higher level than the bars for supporting a product to be grilled thereon.

More conveniently, the griddle pan comprises first and second inter-engaging portions the first of which includes the ridges and the second of which includes the bars.

In a preferred embodiment provided by the present invention and when the griddle pan is in use, the first and second portions thereof are inter-engaged, the bars of the second inter-engaging portion being arranged to lie between, but spaced from the ridges of the first inter-engaging portion to define partially enclosed voids beneath the bars for catching and trapping the juices and fats that exude from a product being griddled.

Conveniently, the first and second inter-engaging portions each comprise mutual co-planar surfaces that are aligned one with the other when the inter-engaging portions are in use, said co-planar surfaces absorbing heat from a heat source for grilling products located on the ridges of the first inter-engaging portion of the griddle pan.

According to a second aspect of the invention there is provided a barrier device for fitting to a griddle pan, the barrier device comprising a plurality of barriers, each barrier being arrangable between successive ridges of a griddle pan, at a height at or lower than the height of successive ridges, the barriers allow liquid to flow from tops of ridges towards the gulleys, and the barriers being arrangable to prevent at least some liquid from spitting from the gulley away through the space between the tops of successive ridges and away from the pan.

There now follows, by way of example of the invention, a detailed description that is to be read with reference to the accompanying drawings in which:

FIG. 1 is a plan view of a griddle pan in a first embodiment of the invention;

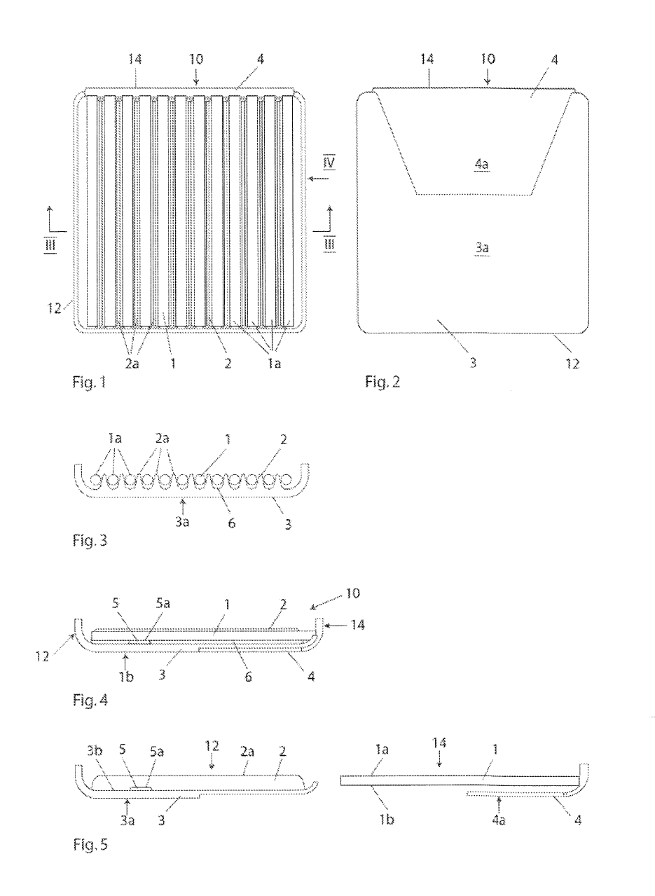

FIG. 2 is an underneath view of the griddle pan of FIG. 1;

FIG. 3 is a fragmentary section view along the line III-III of FIG. 1;

FIG. 4 is a side view of the griddle pan in the direction of the Arrow IV of FIG. 1;

FIG. 5 is a side view of parts of the griddle pan shown in FIG. 4 when disengaged one from the other;

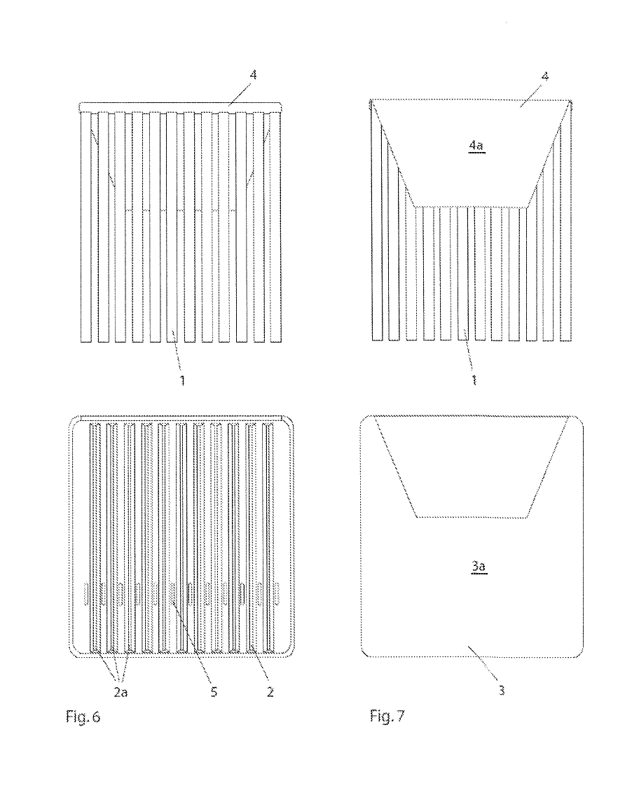

FIG. 6 is a plan view of the parts of the griddle pan as shown in FIG. 5;

FIG. 7 is an underneath view of the parts shown in FIG. 6;

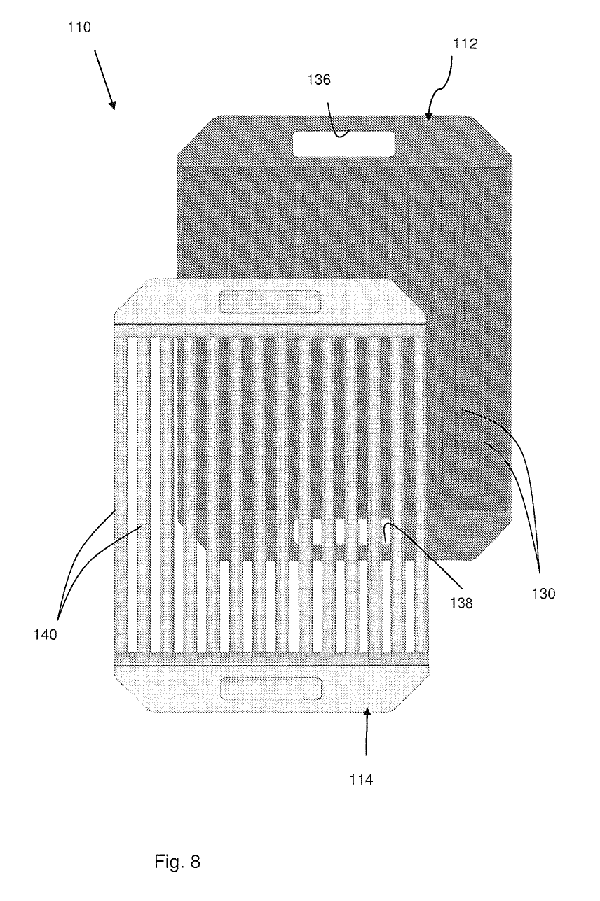

FIG. 8 is a plan view of a griddle pan in a second embodiment of the invention,

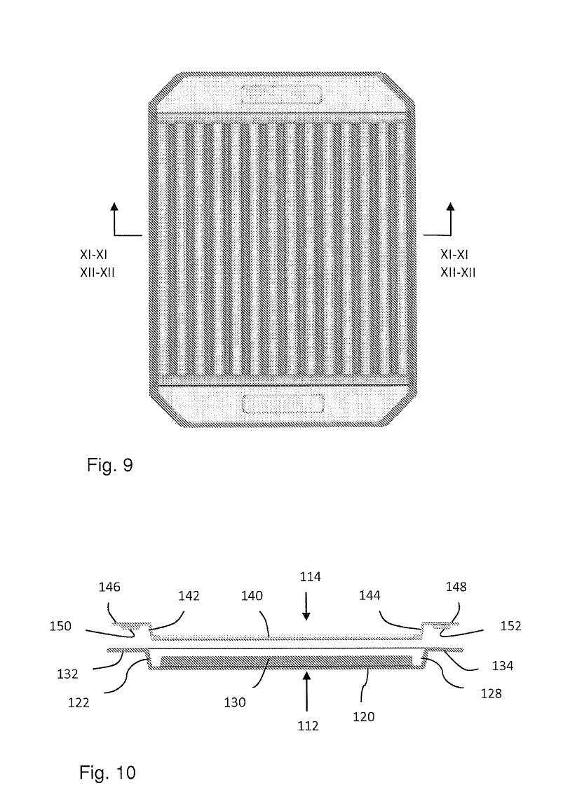

FIG. 9 is another plan view of the griddle pan;

FIG. 10 is a partly sectional view of the parts of the griddle pan arranged one directly above another;

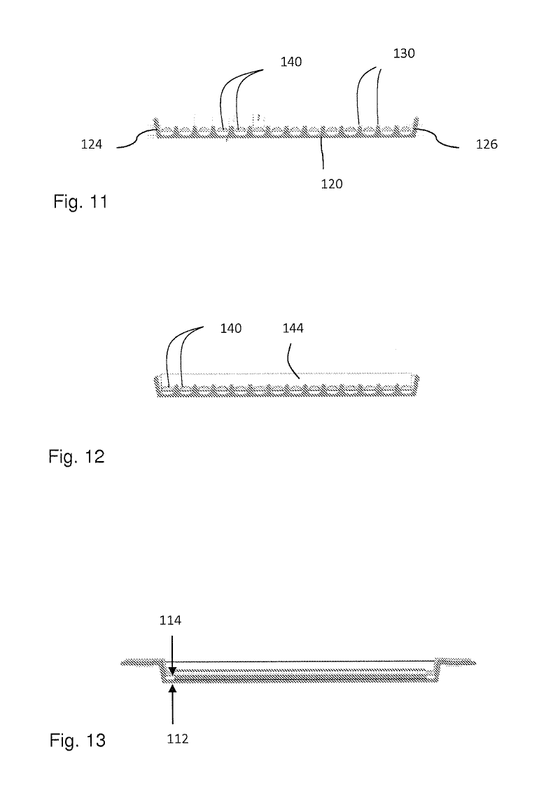

FIG. 11 is a cross sectional view along line XI-XI in FIG. 9;

FIG. 12 is a cross sectional view along line XII-XII in FIG. 9 in the direction of the arrows;

FIG. 13 is a partly sectional view similar to the view in FIG. 10, of the parts of the griddle pan of FIG. 8 arranged together;

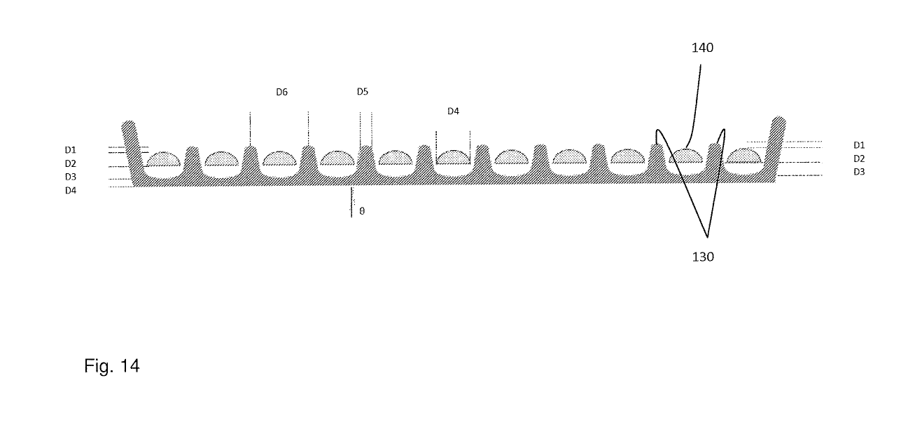

FIG. 14 is an enlarged depiction of FIG. 11,

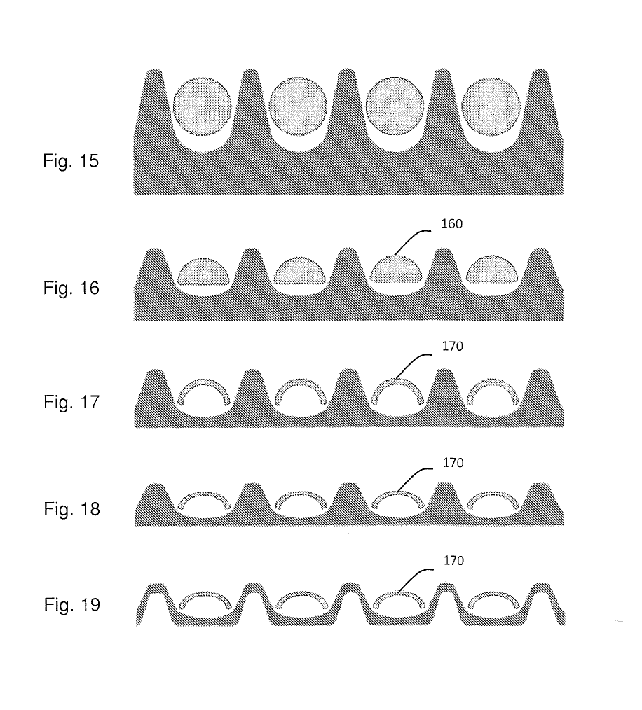

FIG. 15 shows a first possible cross section of the parts of the griddle pan;

FIG. 16 shows a second possible cross section of the parts of the griddle pan;

FIG. 17 shows a third possible cross section of the parts of the griddle pan;

FIG. 18 shows a fourth possible cross section of the parts of the griddle pan;

FIG. 19 shows a fifth possible cross section of the parts of the griddle pan; and

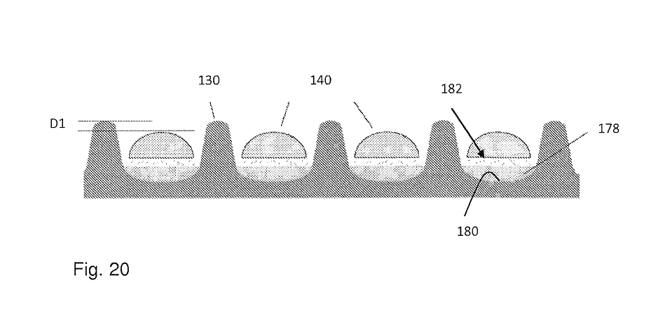

FIG. 20 shows functionality of the griddle pan is use.

The present invention provides a novel griddle pan 10, which generally comprises first and second inter-engaging portions 12 and 14 respectively that, when in use, are co-joined to provide an arrangement wherein bars 1 of the second inter-engaging portion 14 are arranged to lie between, but spaced from side walls of the ridges 2 of the first inter-engaging portion 12. In addition, upper extremities 2a of the ridges 2 are disposed in a plane above that of upper circumferential surfaces 1a of the bars 1, as shown in FIGS. 1 and 3, for supporting food products to be cooked on the griddle pan 10.

The first inter-engaging portion 12 of the griddle pan 10, see FIGS. 2, 3, 4 and 5, comprises a pan base 3 having an underside 3a for engagement with the surface of a heat source, not shown, when in use. Short ridges 5 are provided on an upper surface 3b of the pan base 3 for a purpose to be explained hereinafter.

The second inter-engaging portion 14 of the griddle pan 10, see FIGS. 2, 4 and 5, comprises a pan base 4 having an underside 4a for engagement with the surface of a heat source, not shown, when in use.

When in use, the first and second inter-engaging portions 12 and 14 are co-joined as shown in FIGS. 1 to 4, with the bars 1 of the portion 14 being located between the ridges 2 of the portions 12. Forward end portions 1b of the bars 1 are supported on upper surfaces 5a of the ridges 5 so that a special relationship is established between the bars 1 and the ridges 2 with the bars 1 lying between, but spaced from the ridges 2 as aforesaid.

As shown in FIGS. 2 and 4, the underside 3a of the pan base 3 and the underside 4a of the pan base 4 are co-planar one with the other for mutual engagement with the surface of the heat source.

The co-joining of the first and second inter-engaging portions 12 and 14 creates a series of partially enclosed longitudinal passages 6 wherein, when the griddle pan 10 is in use, the juices and fats that are exuded from the food product that is being grilled pass between the bars and sides of the ridges 2 and are entrapped in the passages 6 and cannot spit or splash as experienced with conventional griddles.

Thus, it will be appreciated that the novel griddle pan 10 provides an efficient way of grilling food products without the disadvantages of conventional griddle pans. In addition, because the griddle pan 10 may be taken apart when not in use, cleaning of the inter-engaging portion 12 and 14 is an easy chore.

Further advantages of the novel griddle pan are that:
1. The two portions 12 and 14 share a relationship with the surface of a heat source when in use, and,
2. The passages 6 provide enclosed, heated voids where the trapped juices and fats will evaporate leading to a reduction thereof. The bars 1 encourage evaporation/reduction of the cooking fats in the voids below them.

Referring to FIGS. 8 to 20, in another embodiment of the invention, a griddle pan 110 comprises a first inter-engaging portion 112 and a second inter-engaging portion 114.

Referring to FIGS. 8 to 14, the first inter-engaging portion 112 comprises a base 120, and first, second, third, and fourth walls 122, 124, 126, 128 (see FIGS. 10 and 11). Spaced ridges 130 extend upwardly from the base 120, and run, in parallel, from near to the first wall 122 to near to the fourth wall 128, which is opposite (see FIG. 10). The ridges 130 are designed to separate food to be griddled from fats, thereby providing a relatively dry cooking surface. The spaces between ridges 130 and first wall 122 and fourth wall 128 allows gulleys between successive ridges to communicate, at both ends of the ridges, so that excessive fat can be distributed among gulleys, and the level of the fats will not rise excessively in certain regions of the pan.

A first flange 132 and a second flange 134, extend, substantially horizontally, from the first wall 122 and fourth wall 128, respectively. The first flange 132 has an opening 136, and the second flange 134 has an opening 138, which are shown in FIG. 8.

Referring especially to FIGS. 8, 10 and 11, the second inter-engaging portion 114 comprises a series of, substantially parallel, bars 140, extending between a first bar wall 142 and a second bar wall 144 (see FIG. 10). The profile of the first bar wall 142 and the second bar wall 144 corresponds to the profile of the first wall 122 and the fourth wall 128 of the first inter-engaging portion 112. A first bar wall flange 146 and a second bar wall flange 148, extend, outwardly, from first the bar wall 142 and the second bar wall 144, respectively. The first bar wall flange 146 has a first downward protrusion 150, and the second bar wall flange 148 has a second downward protrusion 152, to enable easy separation of the elements 112, 114.

In use, the second inter-engaging portion 114 is placed on top of the first inter-engaging portion 112, broadly speaking illustrated by the sequence of drawings in FIGS. 8, 9, 10 and 13. The plane of the series of ribs is substantially parallel to the plane of the series of bars.

Due to the geometry of the griddle pan 110, the bars 140 sit in the spaces between the ribs 130, as shown in FIGS. 9, 11, 12 and 14. Looking at the enlarged view in FIG. 14, there is a space between each bar 140 and its adjacent ribs 130. The space is less than about 3 mm so that spitting is minimized (as will be discussed more below), and more than about 1 mm to allow for viscous liquid to flow past the bar 140 substantially uninhibited, and preferably optimally about 2 mm. Referring to FIG. 14, the tops of the bars 140 are arranged below a straight line connecting successive ridges 130 by a distance D1, in the embodiment shown D1 being about 2 mm. This means the bars do not have to come into contact with food e.g. a steak being grilled on the ridges 130, and hence the bars can be made of a non conductive metal material, which is generally cheaper. The depth of the bar 140 is represented by D2, and may be about 4 mm. The undersides of the bars 140 are also arranged spaced from the base 120. The distance D3 from the base of the gulley to the underside of the bar 140 is optimally about 4 mm. The depth of the base D4 at the lowest point of the gulleys is about 2 mm. The width of the bars 140 may be about 10 mm. The top of each ridge 130 has a curved upper surface, albeit relatively flat, of a width D5, optimally about 3.5 mm. The distance D6 between successive ridges 130 may be about 17.5 mm. The slope from the ridge 130 to the gulley may be inclined at θ degrees to the vertical, where θ is optimally about 11 degrees.

The upper surfaces of the bars 140 are designed to allow easy drainage of cooking fat and liquid. The cross section of the upper surfaces is conveniently a convex curve, a shape which is also easy to clean.

Instead of the circular cross section of bar disclosed in the first embodiment of the invention hereinabove and shown in FIG. 15, the bars 140 can take a different cross section for various reasons. Referring to FIG. 16, the bars can be semi circular cross section 160, with the flat part of the cross section arranged as the underside of the bar. This allows a larger cavity for liquid collection and/or helps to achieve compactness in the height of the griddle pan 110. Although not shown, the bars can be hollow cross section. This allows a reduction in material required for bars.

Referring to FIGS. 17 to 19, the bars 140 can be of various C cross sections 170, open on the underside, allowing a further reduction in material required for bars.

Referring to FIG. 21, in use, during cooking of for example a steak, fat/juices run from the ridges 130 into a cavity 180 defined between successive ridges and form a pool 178. Also, fat/juices run from the tops of the bars 140 into the cavity 180 and form a pool 178. The bars 140 absorb heat from adjacent ribs 130, which helps fat/juices to remain in their liquid state and to run from the tops of the bars into the cavity 180, but the bars are at a lower temperature than the ribs 130 to minimise spitting of fat/juices from the upper surfaces of the bars. The cavity is dimensioned to allow storage of a suitable quantity of fat/juices. Once the fat/juices is in the cavity 180, the underside of the bars 140 presents a barrier to spitting liquid fat/juices 182 from the pool 178 in the cavity 180 through the ridges 130 and away from the grill pan 100. This feature helps to avoid making marks on surrounding kitchen surfaces.

To disassemble the pan, a user can insert their finger into the opening 138 from below the griddle pan, and push the protrusions 152 upwardly from below. The user can then grip the second inter-engaging portion 114 from below and remove it from the first inter-engaging portion 112.

If, optionally, the second inter-engaging portion 114 is made of a conductive, metal, material, (or at least the bars 140 are made of a conductive, metal, material), thermal contact between the first inter-engaging portion 112 and the second inter-engaging portion 114, can allow heat to flow from the base 120 to the bars 140. In this case, the bars 140 can be arranged at a suitable height relative to the ridges, that the bars also support the food to be griddled and act as an additional griddling cooking surface.

It will be appreciated by the reader that features of one embodiment can be incorporated in the other embodiment where they are compatible or can be made compatible. Also, interchangeable terms and minor variants are included within the scope of the invention.

What is claimed is:

1. A griddle pan for domestic use, comprising:
a base provided with a plurality of upwardly extending ridges and respective gulleys between adjacent said ridges; and
a plurality of barriers,
wherein each barrier is insertable in a respective gulley at a height at or lower than the height of said ridges, the barriers to allow liquid to flow from respective tops of said ridges into the gulleys and to prevent at least some of said liquid from spitting from the gulleys away through respective spaces between said tops of said ridges and away from the pan.

2. A griddle pan according to claim 1, wherein said tops of the ridges are disposed higher than the barriers.

3. A griddle pan according to claim 1, wherein a space is provided between each said barrier and the said ridges that define the gulley in which the barrier is inserted, to facilitate drainage.

4. A griddle pan according to claim 3, wherein a said space is provided at each side of said barriers.

5. A griddle pan according to claim 1, wherein said barriers have a cross-section that is semi-circular.

6. A griddle pan according to claim 1, wherein said barriers have a C-shaped cross section

7. A griddle pan according to claim 1, wherein said base comprises a first portion and a second portion that inter-engages said first portion, wherein said first and second have respective handle parts

8. A griddle pan according to claim 7, wherein said handle parts interlock.

9. A griddle pan according to claim 8, wherein said handle parts have interlocking protrusions and gaps.

10. A griddle pan according to claim 7, wherein:
said ridges are provided on said first portion;
the first and second portions comprise mutual co-planar surfaces that are aligned when the first and second portions inter-engage; and
said co-planar surfaces absorbing heat from a heat source for grilling products located on said ridges.

11. A barrier device for fitting to a griddle pan that comprises a base having a plurality of food supporting ridges and respective gulleys defined between adjacent said ridges, said ridges each having a top and a height, the barrier device comprising:
a plurality of barriers, each barrier being insertable between adjacent said ridges of a griddle pan at a height at or lower than the height of said ridges, the barriers to allow liquid to flow from said tops of said ridges towards the gulleys and to prevent at least some said liquid from spitting from the gulleys between said tops of said ridges and away from the pan.

12. (canceled)

13. A griddle pan comprising:
a pan base having food supporting ridges on which food is supported during cooking; and
barriers disposed between adjacent said ridges,
wherein openings are defined between said ridges and said barriers to permit liquid to drain from said food into a space between said barriers and said pan base whereby said liquid is contained in said space and spitting of said liquid from said space is at least partially prevented by said barriers.

14. A griddle pan as claimed in claim 13, wherein:
said barriers comprise respective bars that each have a first end and a second end,
said first ends are connected by a first handle defining member,
said second ends are connected by a second handle defining member and
said bars, first handle defining member and second handle defining member form a barrier device unit releasably fitted to said pan base.

15. A griddle pan as claimed in claim 14, wherein said first and second handle defining members and said pan base are provided with protrusions and openings to receive said protrusions, whereby said barrier device unit can be plug fitted to said pan base.

16. A griddle pan as claimed in claim 13, wherein:
said pan base comprises a base wall and a sidewall disposed about said base wall to define a recess,
said food supporting ridges project upwardly from said base wall within said recess,
respective gulleys are defined between adjacent said ridges,
said barriers are elongate members received in said gulleys
said elongate members extend between a first end support member and a second end support member and
said first and second end support members are configured to seat on said sidewall to support said elongate members in suspension said recess.

17. A griddle pan as claimed in claim 16, wherein:
said sidewall comprises opposed first and second end walls,
respective support members extend horizontally from said first and second end walls and said first and second end support members are configured to seat on said first and second support members.

18. A griddle pan as claimed in claim 13, wherein said barriers comprise bars and said bars each have a cross-section that is one of:
i) circular;
ii) semi-circular; and
iii) C-shaped.

19. A griddle pan as claimed in claim 13, wherein:
said pan base comprises a substantially rectangular base wall and a side wall extending around said base wall to define a recess,
each said food supporting ridge projects upwardly from said base wall within said recess and has a ridge top disposed at a height from said base wall and a pair of inclined ridge sidewalls by which said ridge top is joined to said base wall,
respective gulleys are defined between facing said ridge sidewalls of adjacent said ridges and said base wall, and
said barriers comprise respective bars that are insertable into said gulleys to a position in which said bars are below said height and spaced from said ridges and said base wall whereby said openings are defined between said bars and said ridge sidewalls and said space in which said liquid is contained is defined between said base wall, ridge sidewalls and said bars.

20. A griddle pan as claimed in claim 13 comprising:
a first portion that comprises said food supporting ridges a first part of said pan base, said food supporting ridges extending in parallel spaced apart relation and respective gulleys being defined between adjacent said food supporting ridges; and
a second portion that comprises said barriers and a second part of said pan base,
wherein said first portion is a plug fit with said second portion so that said first and second parts of said pan base can be releasably joined by a push-fitting motion by which said barriers travel in a lengthways direction along the respective said gulleys.

21. A griddle pan as claimed in claim 20, wherein said second part of said pan base comprises a base wall part and a sidewall part and said barriers are cantilevered from said sidewall part.
